(19) United States
(12) Patent Application Publication
(10) Pub. No.: US 2004/0025259 A1
(43) Pub. Date: Feb. 12, 2004

(54) Tool handle structure

(76) Inventor: Chao Chin Yen, Taipei (TW)

Correspondence Address: CHAO CHIN YEN, P.O. BOX 26-757, TAIPEI, TW

(21) Appl. No.: 10/217,286

(22) Filed: Aug. 6, 2002

(51) Int. Cl. B25B 25/00

(52) U.S. Cl. 7/108

(57) ABSTRACT

A tool handle structure comprises a fixation part at a front side and a movable part at a rear side. The fixation part terminates in a front end that includes a fixation slot for fixedly attaching a tool element. The movable part is pivotally assembled with an upper cover in a manner to be capable of being opened and closed relative to each other. A spring element and at least a peeling tool is mounted between the movable part and the upper cover, and a switch is mounted through the movable part and the upper cover to securely close the upper cover on the movable part. With this tool handle structure, different types of tool elements can be mounted to tool handle for adequate utilization. Furthermore, the peeling tool is adapted to peel off and cut the insulating layer of differently sized wires.

### BACKGROUND OF THE INVENTION

1. Field of the Invention

The invention relates to a tool handle structure and, more particularly, to multi-function tool handle capable of mounting different types of tool elements and performing cutting and peeling of a wire insulating layer.

2. Description of the Related Art

Hand-held working tools are indispensable for manual assembly, disassembly, or repair works. Different types of manual works usually require different and specific types of working tools. To have a large panel of working tools at hand, heavy tools cases are therefore often needed to store the different and specific working tools. Such a conventional utilization of working tools is cumbersome. An improvement therefore consists of integrating the functions of the different and specific working tools in a more reduced number of multi-function working tools. An example of this functional integration is described hereafter.

As shown in FIG. 1, a conventional working tool may be, for example, a screwdriver that includes a tool handle 1. The tool handle 1 usually has a single function of hand holding, and includes an end attached with a screwdriver rod 2. Such a working tool therefore is only capable of performing a single function.

Referring to FIG. 2 and FIG. 3, two perspective views illustrate a peeling tool known in the prior art. The peeling tool of the prior art comprises a tool handle that is formed by the assembly of an upper half semi-cylindrical body 3 with a lower half semi-cylindrical body 4. The assembly interface between the upper and lower half semi-cylindrical bodies 3, 4 comprises a pivotal side 5 at which the upper and lower half semi-cylindrical bodies 3, 4 are pivotally assembled with each other by means a pin 7 that inserts through pivot holes 6 and a spring 8. In proximity to the pivotal side 5 are further formed a fitting slot 9 and a fitting groove 10, a fitting piece 11 sliding through the fitting slot 9. Both lower and upper half-semi-cylindrical bodies respectively have planar bases that are provided with corresponding semi-cylindrical cavities 12. The semi-cylindrical cavities 12 further include blade slots 13 in which are received corresponding cutting blades, one 14 of larger size located upward and another 15 of smaller size located relatively downward.

When a peeling operation is performed, the fitting piece 11 is entirely inserted through the fitting slot 9, and both bodies 3, 4 are opened from one another by means of the spring 8. A wire (not shown) then is placed on one of the semi-cylindrical cavities 12, and the two bodies 3, 4 are closed on each other. Meanwhile, the fitting piece 11 is pushed in the fitting groove 10 to block the resilient force of the spring 8. The wire is thereby squeezed to perform peeling.

The above peeling tool can only perform a single function. When peeling of several types of wires and fixation of the wire are required, two types of working tools are needed. If other different operations have to be performed, other types of working tools are further needed, which therefore negatively increases the number of working tools.

### SUMMARY OF THE INVENTION

It is therefore a principal object of the invention to provide a tool handle structure that has a fixation part capable of receiving adequate tool elements needed for the manual operation to perform.

It is another object of the invention to provide a tool handle structure that has a movable part on which is assembled an upper cover, receiving a peeling tool capable of cutting a wire.

Furthermore, it is another object of the invention to provide tool handle structure that has a movable part on which is assembled an upper cover, receiving a peeling tool capable of cutting the insulating layer of differently sized wires.

To accomplish the above and other objectives, a tool handle structure comprises a fixation part at a front side and a movable part at a rear side. The fixation part terminates in a front end that includes a fixation slot capable of fixedly attaching a tool element. The movable part is pivotally assembled with an upper cover in a manner to be capable of being opened and closed relative to each other. A spring element and at least a peeling tool is mounted between the movable part and the upper cover, and a switch is mounted through the movable part and the upper cover to securely close the upper cover on the movable part.

To provide a further understanding of the invention, the following detailed description illustrates embodiments and examples of the invention, this detailed description being provided only for illustration of the invention.

### BRIEF DESCRIPTION OF THE DRAWINGS

The drawings included herein provide a further understanding of the invention. A brief introduction of the drawings is as follows:

FIG. 1 is a perspective view schematically illustrating a traditional tool handle known in the prior art;

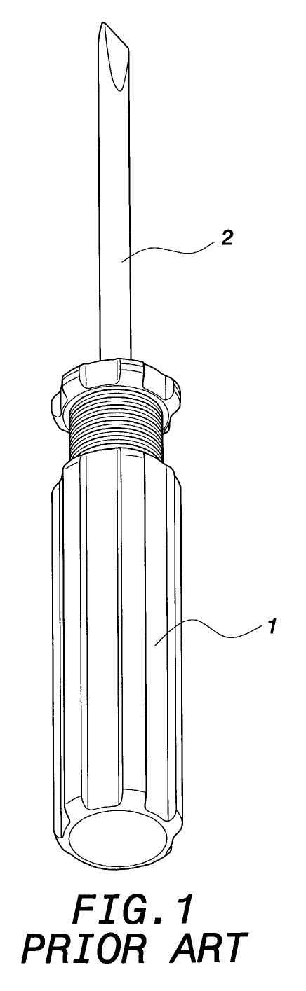

FIG. 2 is a perspective view schematically illustrating another tool handle structure of the prior art that can be movably opened;

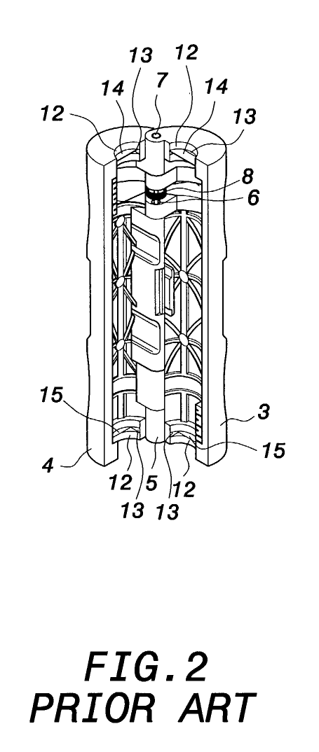

FIG. 3 is a perspective view illustrating the tool handle of FIG. 2 in a closing state;

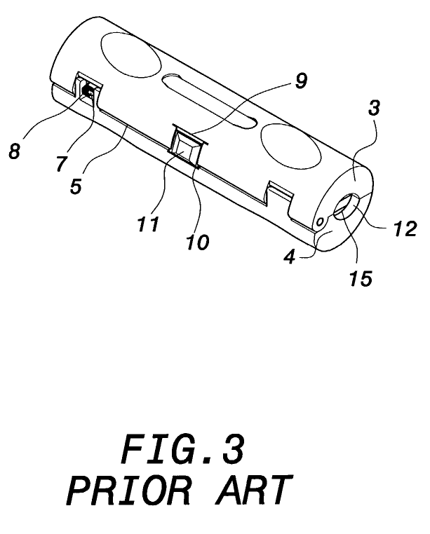

FIG. 4 is an exploded view of a tool handle structure according to a first embodiment of the invention;

FIG. 5 is a perspective view schematically illustrating the a tool handle structure assembled according to the first embodiment of the invention;

FIG. 6 is an exploded view of a tool handle structure according to a second embodiment of the invention; and

FIG. 7 is a perspective view schematically illustrating a tool handle structure assembled according to the second embodiment of the invention.

### DETAILED DESCRIPTION OF THE EMBODIMENTS

Wherever possible in the following description, like reference numerals will refer to like elements and parts unless otherwise illustrated.

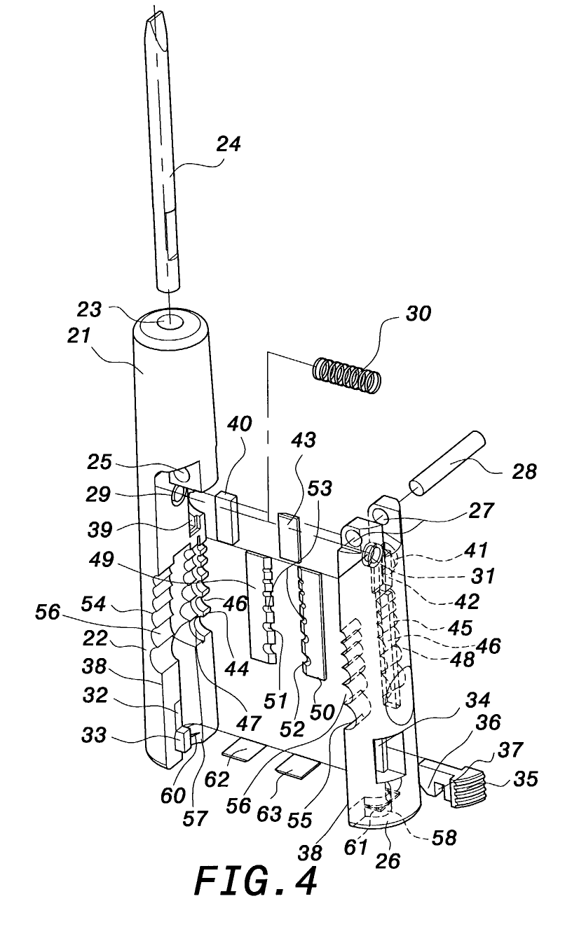

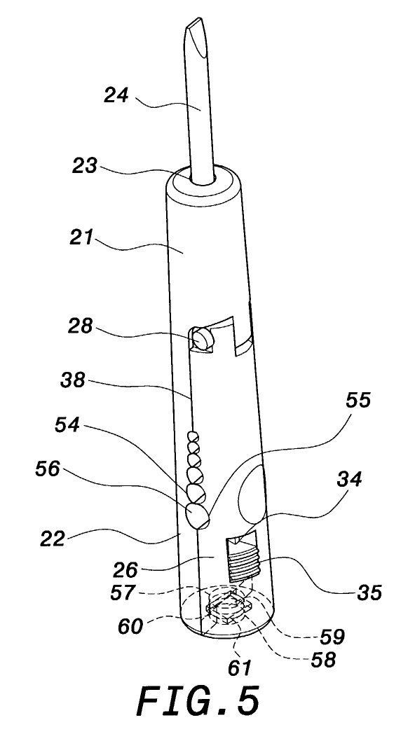

Referring to FIG. 4 and FIG. 5, two schematic views illustrate a tool handle structure according to a first embodiment of the invention. The tool handle structure of the invention comprises a front side where is formed a fixation part 21 and a rear side where is formed a movable part 22.

The fixation part 21 includes a fixation slot 23 through which is mounted a tool element 24 such as a screwdriver rod.

The movable part 22 has a pivot hole 25 at a connecting zone with the fixation part 21. On the movable part 22 is further assembled an upper cover 26 at a front side of which is formed a pivot hole 27 corresponding to the pivot hole 25, a pin 28 inserting through the pivot holes 25, 27. At respective inner sides of the movable part 22 and upper cover 26 proximate to the pivot holes 25, 27 are respectively formed recessed collars 29, 31 that are vis-à-vis each other. Between the recessed collars 29, 31 of the movable part 22 and upper cover 26 is arranged a spring element 30. Proximate to a rear side of the movable part 22 is defined a tenon slot 32 in proximity of which is protruded a projection 33. By the above assembly, the movable part 22 and the upper cover 26 are thereby capable of being opened and closed relatively to each other.

Proximate to a rear side of the upper cover 26 is defined a sliding slot 34 that matches with a switch 35. The switch 35 extends downward into a tenon 36 that corresponds to the tenon slot 32 of the movable part 22. Between the top of the switch 35 and the tenon 36 is cut a notch 37 corresponding to the projection 33 of the movable part 22.

When the upper cover 26 and the movable part 22 are tightly closed on each other, the tenon 36 of the switch 35 inserts in the tenon slot 32 of the movable part 22. Furthermore, the projection 33 snap fits with the notch 37 of the switch 35, which thereby achieves an assembled handle.

The tight closing of the upper cover 26 on the movable part 22 defines an assembly interface 38 there between. A surface of the movable part 22 corresponding to the assembly interface 38 is provided with a cutting board receiving slot 39 capable of receiving a cutting board 40. A surface of the upper cover 26 corresponding to the assembly interface 38 is further provided with a blade receiving opening 41 in which is formed a blade receiving slot 42 capable of receiving a cutting blade 43. More particularly, the cutting blade 43 and the cutting board 40 are received vis-à-vis each other respectively in the upper cover 26 and the movable part 22.

At each side of the assembly interface 38, the movable part 22 and the upper cover 26 respectively include first and second rows of semi-cylindrical cavities 44, 45 that are vis-à-vis each other. The first row of semi-cylindrical cavities 44 and the second row of semi-cylindrical cavities 45 are correspondingly assembled with each other to form a plurality of cylindrical peeling holes 46 of different sizes. A first long blade slot 47 and a second long blade slot 48 are further respectively cut longitudinally through the first row of semi-cylindrical cavities 44 and second row of semi-cylindrical cavities 45 to respectively receive the insertions of first and second long peeling blades 49, 50. The first and second long blades 49, 50 respectively include first and second rows of semi-cylindrically profiled cutting edges 51, 52 that correspond to one another. More particularly, the first and second rows of semi-cylindrically profiled cutting edges 51, 52 are respectively aligned with the first and second rows of semi-cylindrical cavities 44, 45. Thereby, once assembled, the first and second rows of semi-cylindrically profiled cutting edges 51, 52 form a plurality of cutting holes 53 of different sizes that are aligned with the cylindrical peeling holes 46.

At each side of the assembly interface 38, the movable part 22 and the upper cover 26 further respectively include first and second rows of semi-cylindrical wire cavities 54, 55 that are vis-à-vis each other. The first and second rows of semi-cylindrical wire cavities 54, 55 respectively are spaced away transversally from and aligned with the first and second rows of semi-cylindrical cavities 44, 45. Once assembled, the first and second rows of semi-cylindrical wire cavities 54, 55 thereby form a plurality of wire holes 56 of different sizes that are aligned with the cylindrical peeling holes 46 and the cutting holes 53.

At each side of the assembly interface 38, rear ends of the movable part 22 and the upper cover 26 further respectively include a first semi-cylindrical cavity 57 and a second semi-cylindrical cavity 58 that, once assembled with each other, form a cylindrical hole 59. The first and second semi-cylindrical cavities 57, 58 respectively include first and second blade slots 60, 61 where are respectively inserted first and second blades 62, 63.

When the tenon 36 of the switch 35 disengages from the tenon slot 32 of the movable part 22, the spring element 30 separates the upper cover 26 from the movable part 22. One of the cylindrical peeling holes 46 and wire holes 56 then can be adequately selected to insert a wire therein (not shown). Alternatively, the wire may be inserted through cylindrical hole 59 at the rear end of the movable part 22/upper cover 26. By pressing down the upper cover 26 closely on the movable part 22, the insulating layer of the wire then is subjected to the squeeze of either the first/second peeling blades 49, 50 within the cylindrical peeling hole 46 or of the first/second blades 62, 63 within the cylindrical hole 59 at the rear end. Peeling can be thereby effectively performed. An excessively long wire may be further cut by means of the cutting blade 43 and cutting board 40 pressed against each other. Once the peeling operation is completed, the tool element 24, fixed to the fixation part 21, then can be used via hand holding of the assembled handle to fix the wire (not shown) at the desired connection point.

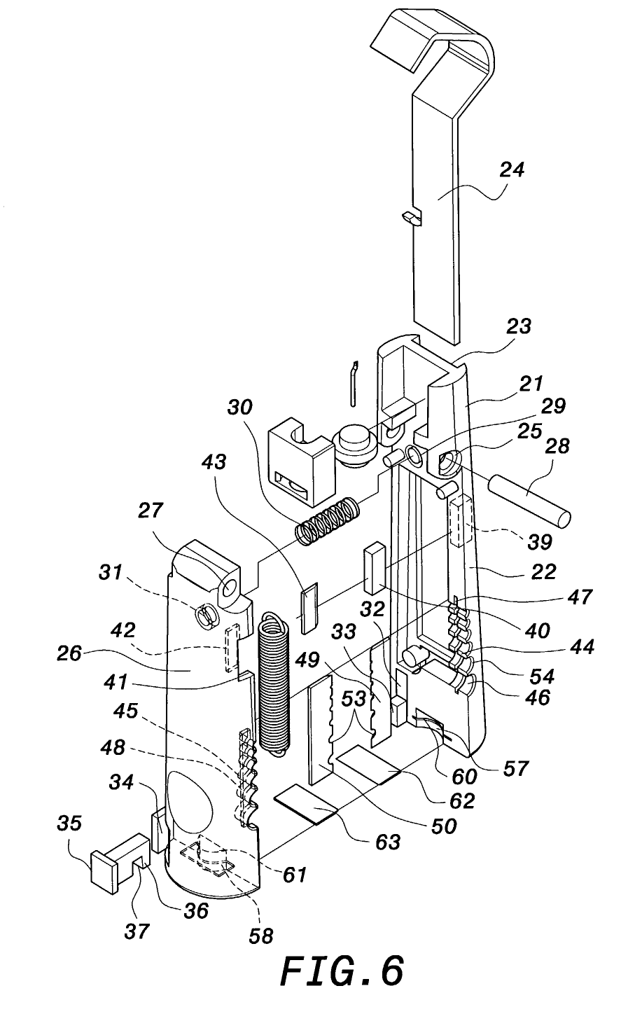

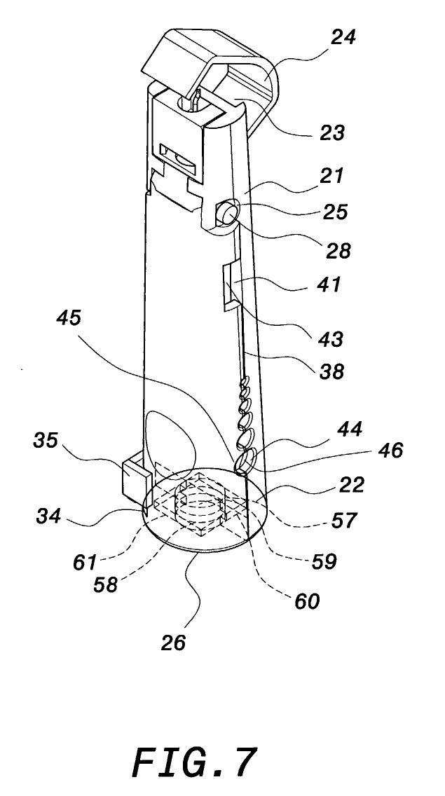

Referring to FIG. 6 and FIG. 7, two schematic views illustrate a second embodiment of the invention in which different types of tool element 24 can be fixedly mounted through the fixation slot 23 of the fixation part 21 of the handle. The tool element 24 therefore may include, for example, a peeling hook and peeling knife, which increases the functionality of the invention.

As described above, the structure of tool handle of the invention includes at least the following advantages. First, the fixation slot of the fixation part can be adaptable to the mount of tool elements adequate to specific utilization demands. Furthermore, the peeling tool of the movable part and upper cover, such as cutting blades, are favorably adapted to the cutting of a wire. Moreover, the peeling tool of the movable part and upper cover is adapted to the cutting of insulating layers of wires having different sizes.

Those skilled in the art will readily appreciate that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A tool handle structure, comprising a fixation part at a front side and a movable part at a rear side, wherein:
the fixation part terminates in a front end that includes a fixation slot for fixedly attaching a tool element;
the movable part is pivotally assembled with an upper cover, a spring element and at least a peeling tool being mounted between the movable part and the upper cover, and a switch being mounted through the movable part and the upper cover for securely closing the upper cover on the movable part.

2. The structure of claim 1, wherein the, tool element is a screwdriver rod.

3. The structure of claim 1, wherein tool element is a peeling hook and peeling knife.

4. The structure of claim 1, wherein the movable part and the upper cover are pivotally assembled with each other by means a pin inserting through pivot holes formed through the movable part and the upper cover.

5. The structure of claim 1, wherein the movable part and the upper cover are respectively formed with recessed collars between which is mounted the spring element.

6. The structure of claim 1, wherein the upper cover includes a sliding slot through which is inserted the switch, the switch including a tenon and a notch and the movable part having a tenon slot and a projection, wherein the tenon inserts in the tenon slot and the projection snap fits with the notch.

7. The structure of claim 1, wherein the movable part of the peeling tool has a cutting board slot for receiving a cutting board, and the movable part has a blade receiving slot for receiving a cutting blade corresponded to the cutting board.

8. The structure of claim 1, wherein the peeling tool comprises a first peeling blade and a second peeling blade that are respectively received in the movable part and the upper cover, the first and second peeling blades respectively including first and second rows of semi-cylindrically profiled cutting edges, and the first and second peeling blades closed each other for forming a plurality of cutting holes of different sizes.

9. The structure of claim 8, wherein the movable part and the upper cover of the peeling tool respectively have first and second rows of semi-cylindrical cavities corresponded to the first rows of semi-cylindrical cavities, the first and the second rows of semi-cylindrical cavities closed each other for forming a plurality of peeling holes of different sizes corresponded to a plurality of the cutting holes, the first and the second rows of semi-cylindrical cavities respectively have a first and a second long blade slot being further longitudinally cut respectively through the first and second rows of semi-cylindrical cavities to respectively receive the first and second peeling blades.

10. The structure of claim 9, wherein the movable part and the upper cover of the peeling tool respectively have a first semi-cylindrical cavity and a second semi-cylindrical cavity corresponded to the first semi-cylindrical cavity, the first semi-cylindrical cavity and the second semi-cylindrical cavity closed for forming a plurality of wire holes of different sizes corresponded to the cutting holes.

11. The structure of claim 1, wherein a lower portion of the upper cover and the movable part respectively have a first semi-cylindrical cavity and a second semi-cylindrical cavity corresponded to the first semi-cylindrical cavity, and the first semi-cylindrical cavity and the second semi-cylindrical cavity respectively have a first blade slot and a second blade respectively received in a first blade and a second blade.
